(19) United States
(12) Patent Application Publication
(10) Pub. No.: US 2004/0045993 A1
(43) Pub. Date: Mar. 11, 2004

(54) Device for the separation of plastic cards

(75) Inventors: Mario Weinfurtner, Roding (DE); Richard Steif, Roding (DE); Johann Heigl, Bernhardswinkel-Lehen (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(73) Assignee: MUEHLBAUER AG, Roding (DE)

(21) Appl. No.: 10/614,750

(22) Filed: Jul. 7, 2003

(30) Foreign Application Priority Data
Jul. 5, 2002 (DE) 102 30 365.7

(51) Int. Cl. B26F 3/00

(52) U.S. Cl. 225/2; 83/23; 225/96

(57) ABSTRACT

The invention relates to a device for the separation of plastic cards, especially chip cards, from a sheet or strip material, with an upper and lower cutting tool giving the cutting outline which are designed to cut into a corresponding upper and lower side of the sheet or strip material with the retention of a residual cross-piece, whereby at least two upper and at least two lower cutting tools arranged in each case next to each other are provided for the forcibly coupled separation of several plastic cards.

The invention relates to a device for the separation of plastic cards, especially chip cards, from a sheet or strip material, with an upper and a lower cutting tool defining the cutting outline which are designed to cut into a corresponding upper and lower side of the sheet or strip material while retaining a residual cross-piece.

Cutting devices of this type have been known for some time and are used for the cutting of plastic with the most different characteristics and also of other non-metallic materials. These cutting devices can produce cut material with much better dimensional stability and better cut edges than traditional punching devices. The dimensional stability is largely independent of the material to be cut, so that plastics difficult to process, e.g. multilayered laminate materials, can be cut in a dimensionally stable manner. In addition, cutting devices of this type can be used to process different materials and material thicknesses without modifying the cutting device to the material in question.

A device of this type is known from WO 85/01241A1. This device is used for the cutting of leather, rubber, paper and plastic and similar materials. The material to be cut is inserted between two wedge-shaped blades and cut from both sides, whereby the device is formed in such a way that the blades cannot touch each other in their end positions. The cutting blades remain in this end position whilst the cut part is separated from the base material. For the separation, a stamp running between the wedge-shaped blades pushes the cut part downwards and separates the cross-piece remaining between the separated part and the original material. After the separation, the part lies between the lower wedge-shaped blades, from where it can be removed.

Devices of this type are used, amongst other things, to cut plastic cards, especially chip cards, for which a high level of dimensional stability is required, from single-layer or multilayer plastic sheet. The increasing relevance of chip cards and multifunctional plastic cards, especially those made from multilayer laminates using most different materials for the individual laminate layers means that, because of the increased numbers and increasing automation, there is a need for improvement and modification of cutting devices to meet the increased requirements.

The object of the present invention is to provide a device for the separation of plastic cards of the type mentioned at the beginning which shows improved design in view of the tougher requirements for the manufacture and the production quality of plastic cards.

This object is solved according to the invention in that at least two upper and at least two lower cutting tools assigned in each case next to each other are provided for the forcibly coupled separation of several plastic cards.

The positioning of several cutting tools next to each other allows several plastic cards to be separated out simultaneously in one cutting and separating stage. The sheet or strip material for the plastic cards, in addition to chip cards these can also be e.g. telephone and customer cards or check and credit cards, can also be processed directly in a device with several cutting tools positioned next to each other. Separation of the sheet or strip material into individual strips is not necessary. The simultaneous separating out of several plastic cards reduces the clippings from the sheet or strip material, which cannot be further processed, since only one edging strip is required between the plastic cards cut out adjacent to each other in contrast to traditionally processed individual strips.

A preferred embodiment proposes that between an upper and a lower cutting tool a fixing device for the positioning and holding of the sheet or strip material is provided at least during the cutting process. Fixing the sheet or strip material during the cutting process improves the dimensional stability of the plastic cards especially if several cutting tools are positioned next to each other.

For the secure positioning and fixing of the sheet or strip material during the cutting process, the fixing device may consist of an upper and a lower guide frame element.

Advantageously, the guide frame elements of at least two adjacent cutting tools can be linked to form a jointly movable guide frame element. The joining of the individual guide frame elements to form a common guide frame reduces the structural work required for the support of the guide frame. Problems with fixing the sheet or strip material using frame elements positioned next to each other can also be avoided by joining the individual guide frame elements, because the joined frame elements fix the material at the same time.

An advantageous embodiment proposes that the guide frame is spring supported. The spring support of the guide frame allows an even fixing of the sheet or strip material, taking into account the individual design, in each case, of the area of the sheet or strip material to be cut.

To reduce the distances between the adjacent cutting tools and thus to give more efficient use of the sheet or strip material, the guide frame may be formed as a single component.

A practical embodiment proposes that the cutting tools each have a wedge-shaped cutting blade defining the cutting outline and that the guide frame element assigned in each case has a window, whereby the cutting blade is formed such that it can move into the assigned window. This means that the guide frame element can fix the sheet or strip material during the cutting process which means that the cuts on the upper and lower side of the sheet or strip material lie exactly over each other and allow a clean cutting edge without displacement.

Advantageously, the guide frame can have at least two adjacent windows which are separated from each other by connecting struts. The formation of a connecting strut between the adjacent windows of the guide frame allows small distances between the plastic cards to be cut on the sheet or strip material and thus a good use of the material.

A variant of this is that the connecting struts of the guide frame are formed as replaceable round bars. The connecting struts form a weak point in the guide frame which is countered by making the connecting struts as round bars and by the fact that they can be replaced.

In order to realize even smaller distances between the adjacent cutting tools and thus to allow an even better use of the sheet or strip material, the connecting struts may have a width of 2 to 5 times the thickness of the plastic cards.

An advantageous embodiment is that the cutting tools have a cutting outline running round in a rectangle with a longer and a shorter side, and the shorter sides of the adjacent cutting tools are aligned parallel to each other. The position of the shorter sides of the cutting tools next to each other produces, due to the short connecting struts, a greater stability of the guide frame and thus also a better fixing of the sheet or strip material.

A modification proposes that between two adjacent wedge-shaped cutting blades a groove is formed to incorporate the connecting struts during the cutting process. The groove between the adjacent wedge-shaped cutting blades enables the cutting tools, in spite of the fixing of the sheet or strip material by the guide frame with connecting struts throughout, to cut several plastic cards simultaneously.

It is also an advantage that the depth of the groove is greater than the height of the connecting struts. The positioning of the connecting struts in the groove between the wedge-shaped cutting blades means that problem-free cutting and separating out of the plastic cards is possible in spite of the wedge-shaped cutting blades being positioned close together. It is a particular advantage if the depth of the groove corresponds at least to the height of the connecting struts plus half the thickness of the plastic cards.

A preferred embodiment proposes that at least one lower and/or one associated upper cutting tool is positioned on a base plate and this base plate has at least one window positioned coaxially to the cutting outline of a cutting tool, whereby the opening surface of the windows corresponds at least to the surface covered by the cutting outline. These windows positioned on the base plate are suitable to allow the separated plastic cards pass through in an area below the device. In this way the plastic cards do not remain in the device or in the sheet or strip material. The cutting and separating out of plastic cards can be carried out without taking into consideration the position of separated out plastic cards in the device or in the sheet or strip material.

A modification of the device with a pressure stamp that can plunge into the cutting outline for the separating out the cut plastic cards from the sheet or strip material proposes that ventilation is provided for the air present or enclosed between the pressure stamp and plastic card and that this is formed such that a pressure difference between the pressure of the air present between the pressure stamp and the plastic card during the separating process and the ambient pressure is limited to a predetermined value. For separation of the plastic cards from the sheet or strip material, the pressure stamp plunges from its rest position into the cutting outline of a cutting tool. The pressure stamp then plunges further into the cutting outline until it meets the cut plastic card and presses it out of the sheet or strip material, destroying the residual cross-piece. After this, the direction of movement of the pressure stamp is reversed and the pressure stamp slides through the cutting outline back to its starting position. After the pressure stamp has plunged into the cutting outline, the air enclosed there is compressed by the pressure stamp moving in the direction of the plastic card whilst a negative pressure builds up underneath the pressure stamp as the pressure stamp moves back. To ensure a safe process sequence, the pressure difference between the pressure of the air present between the pressure stamp and the plastic card and the ambient pressure should be limited to a predetermined value.

To limit the value of the pressure difference to the ambient pressure, the ventilation can be formed such that any disruptive influence of the air present or enclosed between the pressure stamp and the plastic card during the separating of the plastic card is limited to a minimum. A ventilation of this type will prevent the air compressed between the pressure stamp and the plastic cards during the separation process having a reactive effect on the pressure stamp or the plastic card. Such disruptive influences e.g. the uneven movement of the pressure stamp, an uncontrolled movement of the plastic card or the early separation of the plastic card, can, especially at high process speeds, lead to uneven separation of the plastic cards.

An advantageous embodiment proposes that the ventilation is formed such that any suction effect from the pressure stamp on moving back after the separation of the plastic cards is limited to a minimum. Ventilation of this type prevents, after the pressing out of the card, the plastic cards from being sucked up and blown around by the return movement of the pressure stamp and counters the resulting risk of a disruption of the production sequence through the tilting of the plastic cards with the sheet or strip material following behind.

Advantageously, the distance between the pressure stamp and the wedge-shaped cutting blade during the cutting process may be less than the thickness of the plastic cards, preferably less than 0.3 mm. The small distance between the pressure stamp and the cutting blade gives, because of the even separation, clean cut edges and prevents any jamming of the plastic cards between the cutting blade and the pressure stamp as they are being separated out.

One embodiment proposes that the pressure stamp has a front surface in contact with the plastic card during separation and is provided with at least one bored hole open to the front surface to provide ventilation. The bored hole in the front surface creates a simple form of ventilation without affecting the design of the front surface.

For even ventilation, the bored holes in the front surface may be symmetrically to the longitudinal and transverse axes of the front surface running parallel to the side edges of the front surface.

For side air guidance along the side edges of the front surface and of the pressure stamp, the ventilation may be provided by a three-dimensional contouring at the front surface.

For improved separation of the cut plastic cards by peeling off the cards from the sheet or strip material starting at the corners, raised corner areas of the front surfaces may span jointly a conceived area and the side edges in between may be set back in relation to the conceived area. The ventilation in the area of the front surface is provided via the lower-set side edges.

A further embodiment proposes that the ventilation has at least one groove on the front surface. With structural designs which do not permit bored holes in the pressure area or in which such bored holes are not desirable or to support the ventilation through contouring, a sufficient ventilation of the air present between the pressure stamp and the plastic card can be made possible by grooves in the front surface, with the grooves reaching advantageously to the side edges of the front surface.

A practical embodiment is that the ventilation includes air ducts at the cutting tools. Air ducts at the cutting tools mean that, especially with a specific design of the pressure stamp, e.g. using a three-dimensional contouring on the front surface or grooves made on this surface, a particularly good air guidance can be achieved.

A method according to the invention for the separation of plastic cards from a sheet or strip material includes fixing of the sheet or strip material, cutting the upper and lower side of the sheet or strip material with the assigned upper and lower cutting tools defining the cutting contour, while retaining a residual cross-piece and pressing out of the plastic cards from the sheet or strip material. This method proposes that at least two plastic cards are separated forcibly coupled out of the sheet or strip material at the same time. During pressing out, the residual cross-piece running all round, which is left during cutting, is destroyed. With this method, high item numbers are possible in a device for the separation of plastic cards, and the time required per plastic card is less than with traditional methods.

For a simple, accelerated process sequence, at least two plastic cards can be fixed forcibly coupled, cut forcibly coupled and then pressed out at the same time.

A preferred embodiment of the method proposes that when the plastic cards are being pressed out, ventilation is carried out which limits any effect of the air movement created by the pressure stamp on the pressing out and the direction of ejection of the plastic cards to a minimum. This ventilation allows the plastic cards to be separated out from the sheet or strip material more quickly and thus the process sequence to be speeded up again overall, since any tilting or jamming of the plastic cards in the device is prevented by the ventilation.

Advantageously, the pressing out of the plastic cards from the sheet or strip material can be carried out by means of a peeling movement. In this peeling movement, the force required to separate the plastic card is applied initially at points, at least one point in the area of the plastic card, preferably in the area of the corners. The force applied leads in these points to a loosening of the cut plastic cards from the sheet or strip material and/or to a separation of the remaining residual cross-piece in these areas. With further application of force, the plastic card is peeled out of the sheet or strip material, starting at the points of the initial application of force, along the cut cutting outline, like a pulling cut. Peeling out the plastic cards from the sheet or strip material ensures that the plastic cards have clean cut edges. Pressure stamps with three-dimensionally contoured front surfaces are particularly suitable for the peeling out of the plastic cards, whereby raised corner areas of the front surface like a crown contour have been found to be particularly suitable, since the tips of the contoured front surface pick up the corners of the plastic card and the application of force is distributed over several points.

The following provides a more detailed explanation of embodiments of the present invention using a drawing. The figures are as follows:

FIG. 1 shows a section through a front cutaway portion of the device according to the invention for the separating out of plastic cards,

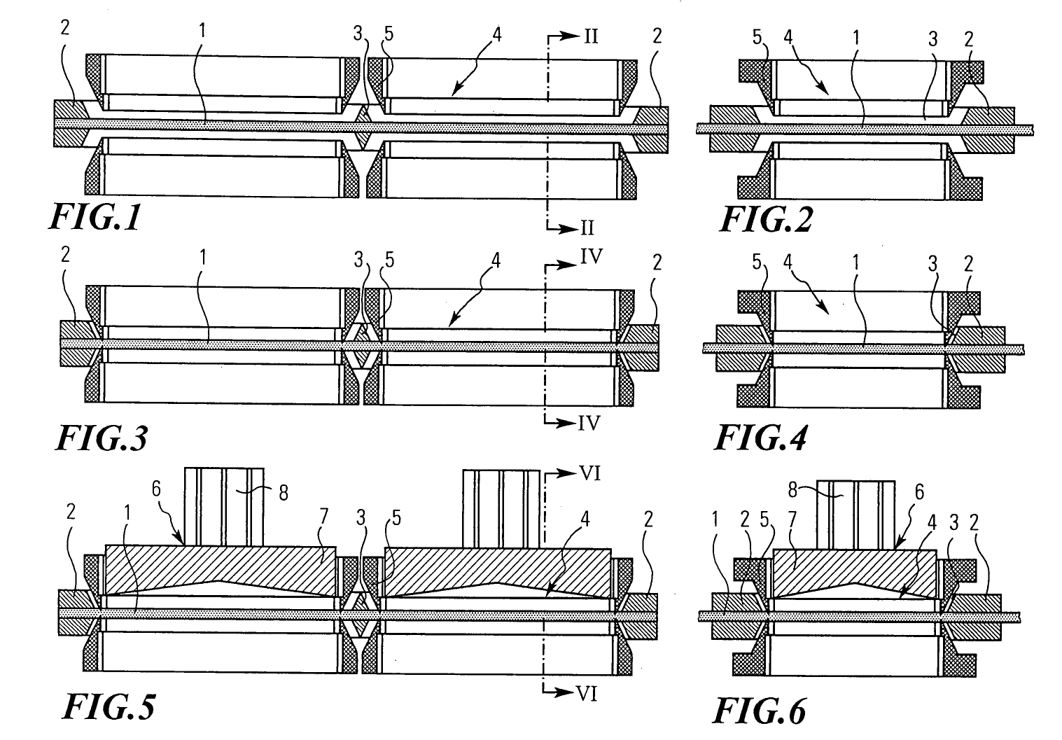

FIG. 2 shows a section through a side cutaway portion of the device from FIG. 1,

FIG. 3 shows a device according to FIG. 1 with the cutting blades cutting,

FIG. 4 shows a device according to FIG. 2 with the cutting blades cutting,

FIG. 5 shows a device according to FIG. 3 with a pressure stamp to separate out the plastic cards,

FIG. 6 shows a device according to FIG. 4 with a pressure stamp to separate out the plastic cards,

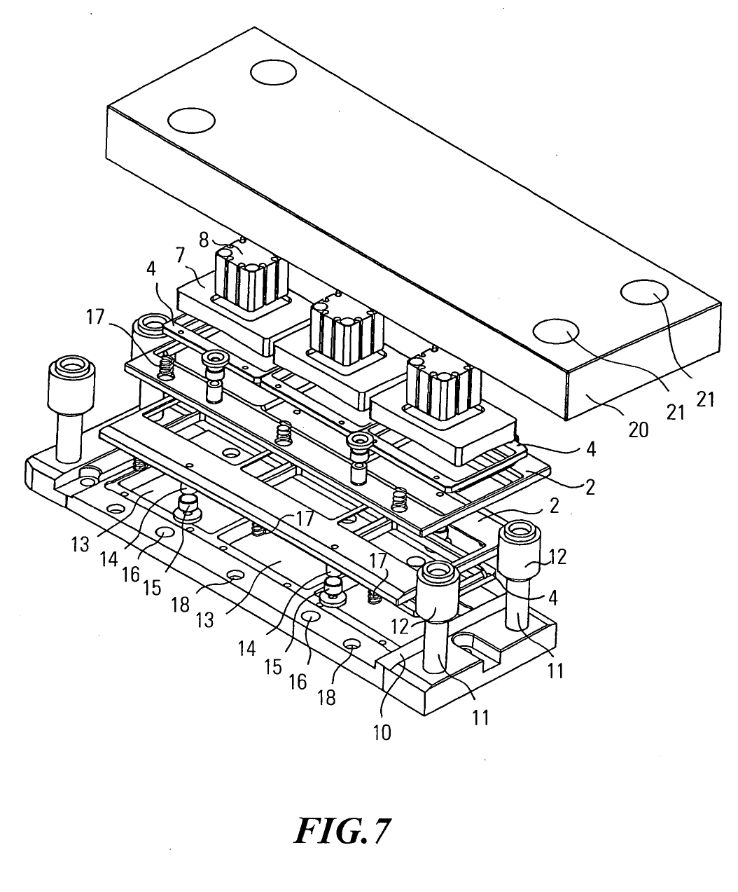

FIG. 7 shows an exploded perspective view of a device according to the invention for the separating out of plastic cards, and

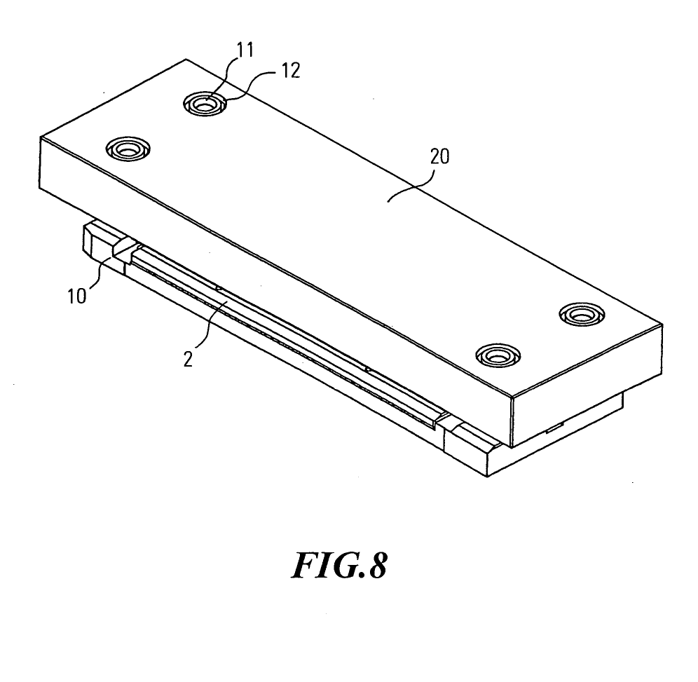

FIG. 8 shows a perspective view of the mounted device under FIG. 7.

The sectional drawings shown in FIGS. 1 to 6 of a device according to the invention describe the operating principle of the forcibly coupled separating out of several plastic cards from a plastic sheet 1. The device includes two upper and two lower cutting tools with a cutting outline running round in a rectangle and an upper and a lower guide frame 2. The guide frames 2 comprise a strut 3 positioned between the adjacent cutting tools 4. The cutting tools 4 comprise the continuous wedge-shaped cutting blades 5 forming the cutting outline, whereby the cutting tools 4 are made to be plungable with only a little play into the guide frame elements formed by the outer frame parts of the guide frame 2 and the strut 3. The front and side view shown in FIG. 1 and FIG. 2 show the fixing of the plastic sheet 1 by the upper and lower guide frame 2. The cutting tools are in their starting position, i.e. the cutting blades 4 are not in contact with the plastic sheet 1.

FIGS. 3 and 4 show the device according to the invention for the separating out of plastic cards with the cutting tools 4 pressed together. The upper and lower cutting tools 4 cut into the corresponding upper and lower sides of the plastic sheet 1. The upper and lower cutting tools 4 do not touch each other. Between the upper and lower cutting blades 5, a small residual cross-piece of the plastic material remains, which continues to connect the cut plastic card with the plastic sheet 1 all round. The outline of the plastic card is specified by the cutting outline running round in a rectangle of the cutting tools 4. The upper and lower cutting blades 5 are exactly over each other in the cutting process so that there is no displacement between the upper and lower cut outline of the plastic card. During the cutting process the plastic sheet 1 continues to be fixed by the upper and lower guide frame 2.

FIGS. 5 and 6 show, alongside the plastic sheet 1 fixed by the guide frames 2 and cut by the cutting tools 4, the pressure stamps 6 for separating out the plastic cards from the plastic sheet 1. The pressure stamps 6 consist of a front surface 7 and a lifting cylinder 8. The front surface 7 of the pressure stamp 6 is between the cutting blades 5 forming the cutting outline of the upper cutting tools 4. The front surface 7 fills almost the entire cutting outline, so that there is only a small gap between the front surface 7 and the cutting blade 5. The surface of the front surface 7 facing the plastic card is contoured to guide the air present or flowing between the pressure stamp 6 and the plastic card. The corner areas of the front surface 7 are higher than the side areas of the front surface 7 lying between them. To separate the plastic card out of the plastic sheet 1, the front surface 7 of the pressure stamp 6 is pressed by the lifting cylinder 8 in the direction of the cut plastic card. The corner areas of the front surface 7 are the first to touch the plastic card. When the lifting cylinder 8 moves out further, the residual cross-piece between the plastic card and the plastic sheet 1 is separated, starting at the corners, and the plastic card is peeled out of the plastic sheet 1 which is fixed by the upper and lower guide frames 2. The separated plastic card falls downwards out of the device.

FIG. 7 shows an exploded perspective view of a device according to the invention for separating out plastic cards with three cutting tools 4 positioned next to each other in a longitudinal direction. This device is mounted on an elongated base plate 10. This rectangular base plate has, on each of the short sides, two bearing bolts 11 fixed vertically on the base plate 10 on which, in each case, a cylindrical bearing sleeve 12 is movably positioned coaxially. The base plate 10 has three openings 13 arranged next to each other in a longitudinal direction through which the separated plastic cards fall downwards out of the device. The openings 13 are separated in each case from each other by a cross-piece of the base plate 10. A cutting tool 4 is positioned in each case above the openings 13 and fixed to the base plate 10. The cutting tools 4 are formed in such a way that a groove to take the strut 3 of the guide frame 2 is formed between the adjoining wedge-shaped cutting blades 5 of the cutting tools 4 positioned next to each other. Above the lower cutting tools 4, the lower guide frame 2 is positioned in such a way that the struts 3 of the guide frame 2 fit into the grooves between the cutting tools 4. The lower guide frame 2 is provided on its longitudinal sides with two vertically arranged sliding bolts 14 which engage the corresponding sliding sleeves 15. These sliding sleeves 15 are fixed in bored holes 16 on the base plate 10. On both longitudinal sides of the lower guide frame 2, three springs 17 are affixed in each case in the middle and at the outer ends. These springs 17 are supported in corresponding blind holes 18 on the base plate 10.

The upper guide frame 2 and the upper cutting tools 4 positioned next to each other are positioned in a layout mirroring the lower elements on a similarly elongated cutting plate 20. This cutting plate 20 has, on each of its short sides, two bored holes 21 to take the bearing sleeves 12. The cutting plate 20 shows in contrast to the base plate 10 instead of the openings 13 three pressure stamps 6 positioned next to each other in a longitudinal direction. The pressure stamps 6 each consist of a front surface 7 or a lifting cylinder 8. The pressure stamps 6 are positioned in such a way in the cutting plate 20 that the front surface 7 fits exactly into the cutting outline of the cutting tool 4. FIG. 8 shows a view of a mounted device.

The cutting tools 4 are fixed in the base plate 10 and the cutting plate 20 in a way that they can be removed individually, so that in the event of damage to or wear of the wedge-shaped cutting blades 5 they can be replaced independently of each other. All upper and lower cutting tools 4, along with both the upper and lower guide frames 2 and the pressure stamps 6, are identical components which means that the number of components necessary for manufacture and spare parts storage are reduced.

For the cutting and separation of plastic cards, a plastic sheet 1 is introduced via one of the longitudinal sides into the device according to the invention shown in FIG. 7 and FIG. 8. The plastic sheet 1 covers at least the width of the three adjacent cutting tools 4. Once the plastic sheet 1 is in the device, pressing on the cutting plate 20 ensures that the plastic sheet 1 is fixed between the spring supported upper and lower guide frames 2. Pressing on the cutting plate 20 again means that the outline of the plastic card is cut by the upper and lower cutting tools from above and below into the plastic sheet. The cutting tools 4 and the guide frames 2 remain in this position, whilst the front surface 7 of the pressure stamp 6 by means of the lifting cylinder 8 presses the plastic card out of the plastic sheet 1 through the upper cutting tools 4 and thus cuts the cross-piece between the plastic card and plastic sheet 1 remaining between the upper and lower wedge-shaped cutting blades 5. The plastic card falls downwards through the openings 13 in the base plate 10 out of the device. After the separation of the plastic card, the front surface 7 is pulled back into its starting position by the lifting cylinder 8 and the pressure on the cutting plate 20 is removed. The guide frames 2 release the plastic sheet 1 so that it can be repositioned between the guide frames 2 before the device fixes the plastic sheet 1 again and separates out further plastic cards.

1. Device for the separation of plastic cards, especially chip cards, from a sheet or strip material, with an upper and lower cutting tool defining the cutting outline which are designed to cut into a corresponding upper and lower side of the sheet or strip material, while retaining a residual cross-piece,
characterized in that at least two upper and at least two lower cutting tools assigned in each case next to each other are provided for the forcibly coupled separation of several plastic cards.

2. Device according to claim 1,
characterized in that between an upper and a lower cutting tool a fixing device for the positioning and holding of the sheet or strip material is provided at least during the cutting process.

3. Device according to claim 2,
characterized in that the fixing device consists of an upper and a lower guide frame element.

4. Device according to claim 3,
characterized in that the guide frame elements of at least two adjacent cutting tools are linked to form a jointly movable guide frame element.

5. Device according to claim 4,
characterized in that the guide frame is spring supported.

6. Device according to claim 4 or 5,
characterized in that the guide frame is formed as a single component.

7. Device according to one of the claims 3 to 6,
characterized in that the cutting tools each have a wedge-shaped cutting blade defining the cutting outline and the guide frame element assigned in each case has a window, whereby the cutting blade is formed such that it can move into the assigned window.

8. Device according to claim 7,
characterized in that the guide frame has at least two adjacent windows which are separated from each other by connecting struts.

9. Device according to claim 8,
characterized in that the connecting struts of the guide frame are formed as replaceable round bars.

10. Device according to claim 8 or 9,
characterized in that the connecting struts have a width of 2 to 5 times the thickness of the plastic cards.

11. Device according to one of the claims 1 to 10,
characterized in that the cutting tools have a cutting outline running round in a rectangle with a longer and a shorter side and the shorter sides of the adjacent cutting tools are aligned parallel to each other.

12. Device according to claim 11,
characterized in that between two adjacent wedge-shaped cutting blades a groove is formed to incorporate the connecting strut during the cutting process.

13. Device according to claim 12,
characterized in that the depth of groove is greater than the height of the connecting struts.

14. Device according to one of the claims 1 to 13,
characterized in that at least one lower and/or one associated upper cutting tool is positioned on a base plate and this base plate has at least one window positioned coaxially to the cutting outline of a cutting tool, whereby the opening surface of the windows corresponds at least to the surface covered by the cutting outline.

15. Device according to one of the claims 1 to 14 with a pressure stamp that can plunge into the cutting outline for separating out the cut plastic cards from the sheet or strip material,
characterized in that ventilation is provided for the air present or enclosed between the pressure stamp and the plastic card and that this is formed such that a pressure difference between the pressure of the air present between the pressure stamp and the plastic card during the separation process and the ambient pressure is limited to a predetermined value.

16. Device according to claim 15,
characterized in that the ventilation to limit the value of the pressure difference to the ambient pressure is formed such that any disruptive influence of the air present or enclosed between the pressure stamp and the plastic card during separation of the plastic card is kept to a minimum.

17. Device according to claim 15 or 16,
characterized in that the ventilation is formed such that any suction effect from the pressure stamp on moving back after the separation of the plastic card is kept to a minimum.

18. Device according to one of the claims 15 to 17,
characterized in that the distance between the pressure stamp and the wedge-shaped cutting blade during cutting process is less than the thickness of the plastic cards, and preferably less than 0.3 mm.

19. Device according to one of the claims 15 to 18,
characterized in that the pressure stamp has a front surface that is in contact with the plastic card during separation and is provided with at least one bored hole open to the front surface to provide ventilation.

20. Device according to claim 19,
characterized in that the bored holes in the front surface are symmetrical to the longitudinal and transverse axes of the front surface running parallel to the side edges of the front surface.

21. Device according to one of the claims 15 to 20,
characterized in that the ventilation is provided by a three-dimensional contouring at the front surface.

22. Device according to claim 21,
characterized in that raised corner areas of the front surface span jointly a conceived area and that side edges in between are set back in relation to the conceived area.

23. Device according to one of the claims 15 to 22,
characterized in that the ventilation has at least one groove on the front surface.

24. Device according to one of the claims 15 to 23,
characterized in that the ventilation includes air ducts at the cutting tools.

25. Method for the separation of plastic cards with one of the devices from the claims 1 to 24 with the following stages:
Fixing the sheet or strip material,
Cutting the upper and lower side of the sheet or strip material with the assigned upper and lower cutting tools defining the cutting outline, while retaining a residual cross-piece;
Pressing out of the plastic cards from the sheet or strip material,
characterized in that at least two plastic cards are separated forcibly coupled out from the sheet or strip material at the same time.

26. Method according to claim 25,
characterized in that at least two plastic cards are fixed forcibly coupled, cut forcibly coupled and then pressed out at the same time.

27. Method according to claim 25 or 26,
characterized in that as the plastic cards are being pressed out, ventilation is carried out which limits any effect of the air movement created by the pressure stamp on the pressing out and the direction of ejection of the plastic cards to a minimum.

28. Method according to one of the claims 25 to 27,
characterized in that the pressing out of the plastic cards from the sheet or strip material is carried out by means of a peeling movement.
